(19) United States
(12) Patent Application Publication
(10) Pub. No.: US 2017/0060162 A1
(43) Pub. Date: Mar. 2, 2017

(54) CONTROL SYSTEMS AND METHODS FOR UTILITY GRID FREQUENCY REGULATION PROGRAMS

(71) Applicant: Green Charge Networks LLC, Santa Clara, CA (US)

(72) Inventors: Mathew Holzman, Redwood City, CA (US); Dagong Zhou, Calgary (CA)

(21) Appl. No.: 15/253,519

(22) Filed: Aug. 31, 2016

Related U.S. Application Data
(60) Provisional application No. 62/212,511, filed on Aug. 31, 2015.

(51) Int. Cl. G05F 1/66; G05B 17/02; G06F 17/50; G05B 13/04

(52) U.S. Cl. CPC G05F 1/66; G05B 13/048; G05B 17/02; G06F 17/5009

(57) ABSTRACT

Methods and systems of controlling frequency regulation system controllers in a utility grid frequency regulation program are shown and described. One method includes providing historical frequency regulation data and energy storage device specifications of an energy storage device connected to a frequency regulation system. The method also includes simulating frequency regulation operations by the energy storage device, with each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds. A frequency regulation system controller may be used to implement the upper and lower state of charge thresholds of the simulated frequency regulation operation that has the lowest costs of program participation.

### CROSS REFERENCE TO RELATED APPLICATIONS

This application claims the benefit of priority from U.S. Provisional Application No. 62/212,511, filed 31 Aug. 2015 and entitled CONTROL SYSTEMS AND METHODS FOR UTILITY GRID FREQUENCY REGULATION PROGRAMS, the disclosure of which is incorporated, in its entirety, by this reference.

### TECHNICAL FIELD

The present disclosure generally relates to systems and methods for determining and implementing efficient control logic for a utility grid frequency regulation system and specifically relates to systems and methods for minimizing the costs of participating in the frequency regulation system.

### BACKGROUND

For myriad technical reasons, large-scale electrical utility grid networks operate using alternating current (AC) signals. AC signals have alternating polarity, and the frequency of the polarity changes must be carefully controlled. In order to do so, electrical utility providers employ participants in “frequency regulation” programs wherein the participants use devices called frequency regulation systems to dynamically act as a source or sink of power depending on grid conditions. When the grid needs power to enter the grid, the frequency regulation systems are directed by the utility provider to provide power, and when the grid needs power to leave the grid, the frequency regulation systems draw power.

Typically, a frequency regulation system includes a battery or other energy storage device and an inverter or other power conversion device. When the grid needs power to move in one direction (e.g., into or out of the grid), the battery is discharged or charged at the rate requested by the utility provider. Thus, a frequency regulation system may be requested to discharge at a rate of 200 kilowatts (kW) over a specified time interval, so the inverter discharges the battery to the grid at 200 kW for the specified time interval.

A frequency regulation system may also have the ability to use a reserved portion of the overall power capacity of the inverter or other converter, wherein the system may opt to respond to the power request at a rate other than the one requested by the utility provider. The reserved portion may alternatively be referred to as a flexible capacity of the frequency regulation system since the participant is allowed flexibility in responding to the frequency regulation requests up to the flexible capacity value. For example, if the frequency regulation system has a total available power capacity of 500 kW, and 50 kW (i.e., 10 percent) is the reserved portion, then if the grid requests 200 kW of power to be supplied to the grid, the frequency regulation system may opt to supply anywhere between 150 kW and 250 kW of power by modifying the request by the reserved portion.

Utility providers track the responses of the frequency regulation systems in the frequency regulation program and offer incentives to participants that respond to the frequency regulation requests. They may also penalize participants that do not respond to the requests or that respond to the requests at a power level other than the one requested, such as when participants use the reserved portion. Thus, it is in the participants' best interests to provide power at the time and rate requested by the utility provider.

There is therefore a need for improvements in the operation of frequency regulation systems in utility grid frequency regulation programs.

### SUMMARY

In one aspect of the disclosure, a method of controlling a frequency regulation system controller of a participant in a utility grid frequency regulation program is shown and described. The method may comprise providing historical frequency regulation data of a participant in a utility grid frequency regulation program and providing energy storage device specifications of an energy storage device connected to a frequency regulation system. The energy storage device specifications may comprise an energy storage capacity and a state of charge. The method may also include simulating a plurality of frequency regulation operations by the energy storage device, with each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds. The method may also include implementing, via a frequency regulation system controller, the upper and lower state of charge thresholds of the simulated frequency regulation operation having the lowest cost of participating in the utility grid frequency regulation program.

In some embodiments, the method may comprise determining a reserve value available to the participant when participating in the utility grid frequency regulation program.

Each simulated frequency regulation operation may comprise assigning the upper state of charge threshold to the energy storage device and assigning the lower state of charge threshold to the energy storage device, wherein each of the simulated frequency regulation operations have different upper and lower state of charge thresholds. Each simulated operation may also include simulating charging and discharging the energy storage device in response to the historical frequency regulation data, wherein a reserve value of the frequency regulation system is used only when the state of charge of the energy storage device is below the lower state of charge threshold or above the upper state of charge threshold, and calculating the cost of participating in the simulated frequency regulation operation, with the cost being dependent upon the use of the reserve value.

The cost of using the frequency regulation system of each simulated frequency regulation operation may include a cost of health degradation of the energy storage device and/or a cost of non-compliance with a frequency regulation command from a utility grid operator. In some cases, implementing the upper and lower state of charge thresholds comprises physically providing or installing a frequency regulation system that uses upper and lower state of charge thresholds for the participant. In some arrangements, the historical frequency regulation data comprises frequency regulation commands from a utility grid operator or frequency regulation program operator.

In another aspect of the disclosure, a computing device is provided that may be configured for generating a probability assessment for peak demand reduction for a utility customer using a conditional-output energy generator. The computing device may comprise a processor and memory in electronic communication with the processor, wherein the memory stores computer executable instructions that, when executed by the processor, cause the processor to perform steps. The steps may include providing historical frequency regulation data of a participant in a utility grid frequency regulation program; providing energy storage device specifications of an energy storage device connected to a frequency regulation system, with the energy storage device specifications comprising an energy storage capacity and a state of charge; simulating a plurality of frequency regulation operations by the energy storage device, with each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds; and implementing, via a frequency regulation system controller, the upper and lower state of charge thresholds of the simulated frequency regulation operation having the lowest cost of participating in the utility grid frequency regulation program.

Another aspect of the disclosure relates to a non-transitory computer-readable storage medium storing computer executable instructions that, when executed by a processor, cause the processor to perform the steps of: providing historical frequency regulation data of a participant in a utility grid frequency regulation program; providing energy storage device specifications of an energy storage device connected to a frequency regulation system, with the energy storage device specifications comprising an energy storage capacity and a state of charge; simulating a plurality of frequency regulation operations by the energy storage device, with each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds; and implementing, via a frequency regulation system controller, the upper and lower state of charge thresholds of the simulated frequency regulation operation having the lowest cost of participating in the utility grid frequency regulation program.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a block diagram of a customer site according to an embodiment of the present systems and methods.

FIG. 2 is a block circuit diagram of a computing system according to an embodiment of the present systems and methods.

FIG. 3A is a chart showing example grid commands for a frequency regulation program over time.

FIG. 3B is a chart showing the state of charge of an energy storage device over time.

FIG. 4A is a chart showing example grid commands for a frequency regulation program over time.

FIG. 4B is a chart showing the state of charge of an energy storage device over time.

FIG. 5 shows an example module for implementing an embodiment of the present disclosure.

FIG. 6 shows a process flowchart according to another embodiment of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

In frequency regulation programs, participants do not always have the ability to provide power at the time and rate requested by a utility grid operator. The participant may have an energy storage device used for frequency regulation that, over time, is requested to discharge repeatedly or for a long period of time, thereby depleting the state of charge of the device. If the device is depleted when a new discharge request is received, the participant may not be able to respond to the request, leading to penalties from the frequency regulation program operator. Likewise, if the device is fully charged, the device is unable to respond to requests that require charging. Thus, the participant may wish to use the reserve option to prevent the energy storage device from over-charging or over-depleting so that it can continue to respond to frequency regulation requests.

One way to prevent full-charge or no-charge conditions would be to cause the frequency regulation system to use the reserve option in every charge or discharge event. The reserve would allow the energy storage to have a state of charge as close as possible to 50 percent and thus would keep the energy storage device at a state of charge as far as possible from full-charge and no-charge. This arrangement, however, would constantly incur the expense or penalties that result from using the reserve option, particularly if the participant is always using the full amount of reserve value available. Thus, over-use of the reserve option may lead to unnecessary penalties from the frequency regulation program operator, particularly when the frequency regulation system has the ability to respond to requests without use of the reserve option.

The present systems and methods may help a frequency regulation program participant determine the optimal number of times they can respond to a frequency regulation request while not using the reserve option and also while limiting the number of times that the frequency regulation system is unable to respond due to energy storage being depleted or fully charged. In order to do so, one aspect of the present systems and methods is a method of programming and/or controlling a frequency regulation controller of the participant in the utility grid frequency regulation program. The method may comprise performing a plurality of simulated frequency regulation operations that could be performed by the energy storage device. In each of the plurality of simulated frequency regulation operations, a different upper state of charge threshold and lower state of charge threshold are assigned to a simulated frequency regulation system. A computing device simulates charging and discharging the energy storage device using historical frequency regulation data or simulated frequency regulation data. In these simulations, the reserve value of the frequency regulation system is only used when the state of charge of the energy storage device rises above the upper state of charge threshold or falls below the lower state of charge threshold. This may allow the simulated energy storage device to avoid having too much or too little charge while still being able to have the charge “drift” up or down without incurring the costs or penalties associated with using the reserve value of the participant.

The costs or penalties that would be incurred by the use of the reserve value (and/or non-response to a simulated frequency regulation request) in each iterated simulation are recorded and accumulated, and eventually upper and lower state of charge thresholds are established that correlate with the lowest costs or penalties. A frequency regulation controller for the energy storage device may then be programmed to operate using the upper and lower state of charge threshold values that minimize the costs or penalties to the participant in a live operation of the frequency regulation system.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, and/or add other procedures or components as appropriate. For instance, the methods described may be performed in an order different from that described, and various steps may be added, omitted, and/or combined. Also, features described with respect to certain embodiments may be combined in other embodiments.

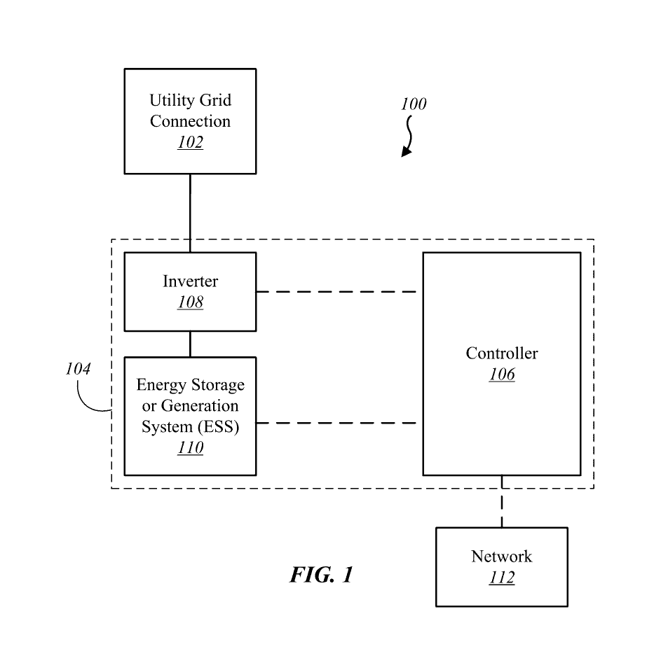

Referring now to the figures in detail, FIG. 1 shows a block diagram of an electronic system 100 that may be used to implement the present systems and methods. The system 100 may be installed at the site of a participant in a frequency regulation program. The system 100 may comprise a utility grid connection 102 to which a frequency regulation system 104 is connected. The frequency regulation system 104 may comprise a controller 106, an inverter 108 (or other converter), and an energy storage system (ESS) 110. The ESS 110 is connected to the grid connection 102 via the inverter 108 and may comprise a battery array, fuel cell, or other energy storage device that can be charged and discharged to regulate the frequency of the power on the grid. The ESS 110 may have characteristics such as an energy storage capacity (e.g., in kilowatt-hours (kWh)), battery voltage, battery current, state of charge, and other related characteristics that are monitored by the controller 106. The controller 106 may be connected to the inverter 108 and ESS 110 to control how they draw (or send) power from (or to) the grid in conformance with frequency regulation requests that are sent to the participant via a network 112. In order to do so, the controller 106 may specify the rate of energy transfer (i.e., power level) and the direction of energy transfer (to or from the grid connection 102) of the inverter 108.

The inverter 108 may comprise electronics configured to connect the ESS 110 to an electrical panel and/or other electrical interfaces of the participant. Thus, the inverter 108 may adapt the output of the ESS 110 for providing energy to the panel or other interfaces at the site. The inverter 108 may therefore comprise inverters such as AC-DC or DC-AC inverters, converters such as DC-DC converters, step-up or step-down converters, and related conversion equipment. The inverter 108 may also comprise specifications such as a minimum and maximum power output or rate of energy transfer from the ESS 110.

The controller 106 may be a computer system configured to receive information from the ESS 110, inverter 108, and/or a network 112. The controller 106 may monitor the frequency regulation requests of the utility provider to determine when to discharge and charge the ESS 110 via the inverter 108. The controller 106 may also access a database of historical frequency regulation requests.

While FIG. 1 shows a single customer site having a single inverter 108 and ESS 110, in some embodiments the inverter 108 and ESS 110 may comprise a plurality of inverters 108 or other conversion devices and a plurality of energy storage systems that work cohesively or together as a single unit. Thus, it will be understood by those having ordinary skill in the art that the present system 100 may be implemented with various numbers of batteries, inverters, and other equipment required to provide frequency regulation.

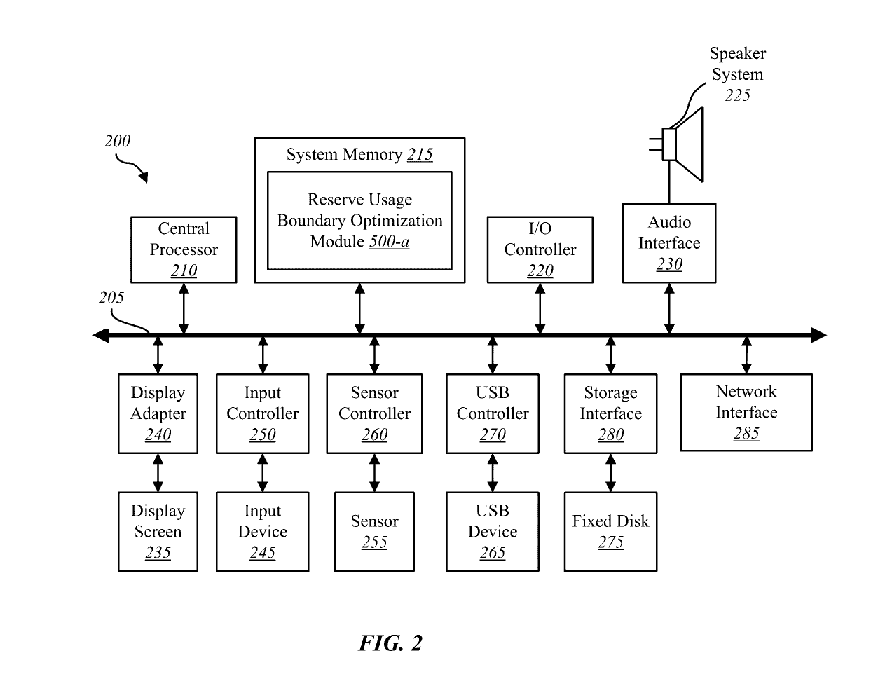

FIG. 2 is a block diagram of a computer system 200 that may be used to implement the present systems and methods for controlling or programming a frequency regulation controller of a participant in a utility grid frequency regulation program. In some embodiments, the computer system 200 is part of controller 106 of FIG. 1. Computer system 200 includes a bus 205 which interconnects major subsystems of computer system 200, such as a central processor 210, a system memory 215 (typically RAM, but which may also include ROM, flash RAM, or the like), an input/output controller 220, an external audio device, such as a speaker system 225 via an audio output interface 230, an external device, such as a display screen 235 via a display adapter 240, an input device 245 (e.g., a keyboard, touchscreen, etc.) (interfaced with an input controller 250), a sensor 255 (interfaced with a sensor controller 260), one or more universal serial bus (USB) device 265 (interfaced with a USB controller 270), and a storage interface 280 linking to a fixed disk 275. A network interface 285 is also included and coupled directly to bus 205.

Bus 205 allows data communication between central processor 210 and system memory 215, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output System (BIOS) which controls basic hardware operation such as the interaction with peripheral components or devices. For example, computer-readable instructions of a reserve usage boundary optimization module 300-a which may implement the present systems and methods may be stored within the system memory 215. Applications resident with computer system 200 are generally stored on and accessed via a non-transitory computer readable medium, such as a hard disk drive (e.g., fixed disk drive 275), an optical drive (e.g., an optical drive that is part of a USB device 265 or that connects to storage interface 280), or other storage medium. Additionally, applications can be in the form of electronic signals modulated in accordance with application and data communication technology when accessed via network interface 285.

Storage interface 280, as with the other storage interfaces of computer system 200, can connect to a standard computer readable medium for storage and/or retrieval of information, such as a fixed disk drive 275. Fixed disk drive 275 may be a part of computer system 200 or may be separate and accessed through other interface systems. A modem connected to the network interface 285 may provide a direct connection to a remote server via a telephone link or to the Internet via an internet service provider (ISP). Network interface 285 may provide a direct connection to a remote server via a direct network link to the Internet via a POP (point of presence). Network interface 285 may provide such connection using wireless techniques, including digital cellular telephone connection, Cellular Digital Packet Data (CDPD) connection, digital satellite data connection or the like.

Many other devices or subsystems (not shown) may be connected in a similar manner. Conversely, all of the devices shown in FIG. 2 need not be present to practice the present systems and methods. The devices and subsystems can be interconnected in different ways from that shown in FIG. 2. The operation of a computer system such as that shown in FIG. 2 is readily known in the art and is not discussed in detail in this application. Code to implement the present disclosure can be stored in a non-transitory computer-readable medium such as one or more of system memory 215, or fixed disk 275. The operating system provided on computer system 200 may be MS-DOS®, MS-WINDOWS®, OS/2®, UNIX®, MAC OS X®, iOS®, Android®, Linux®, or another known operating system.

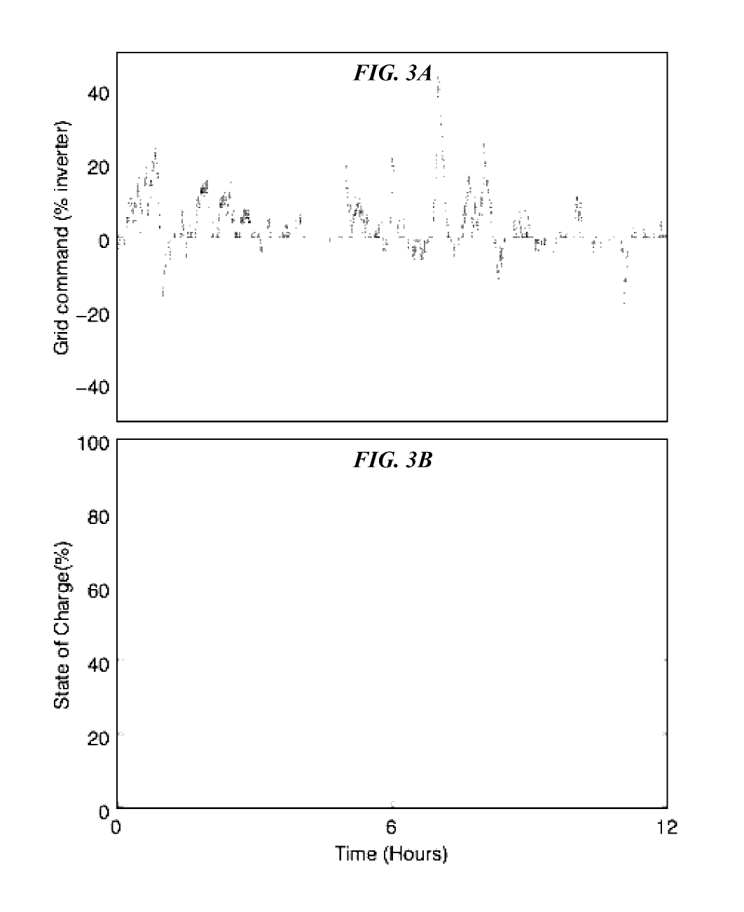

As discussed above, one way to prevent full-charge or no-charge conditions that cause faults or penalties in the operation of the participant's frequency regulation system is to cause the frequency regulation system to use the reserve option in every charge or discharge event. FIGS. 3A-3B illustrate an example of the results of this behavior. FIG. 3A shows an example frequency regulation command profile. The vertical axis in FIG. 3A represents the percentage of the inverter's output that the grid operator requests. If the grid command is positive, the grid operator requests sending power to the grid, and if the grid command is negative, the grid operator requests drawing power from the grid. As shown in the 12-hour period of FIG. 3A, the grid commands may fluctuate greatly from minute-to-minute or hour-to-hour and may frequently change polarity.

FIG. 3B shows the state of charge of an energy storage device over that 12-hour period when the control protocol and programming of the frequency response system elects to consistently use the reserve option to maintain 50 percent state of charge (SOC) as well as possible. The energy storage device remains relatively consistently at or near 50 percent SOC, so there is little or no risk of the energy storage device running out of charge or having too much charge when a frequency regulation request is received. Thus, no mis-performance (i.e., failure to perform) penalties are assessed. There are significant costs or penalties associated with using the reserve option, however. Using the center-seeking system of FIGS. 3A-3B, an annual frequency regulation payment of 3,100,000 Euros would be reduced by 450,000 to 1,400,000 Euros for “energy adjustment costs” or reserve usage penalties. Thus, the estimated gross income from participating in the frequency regulation program would be between 1,700,000 and 2,650,000 Euros after the energy adjustment costs are deducted.

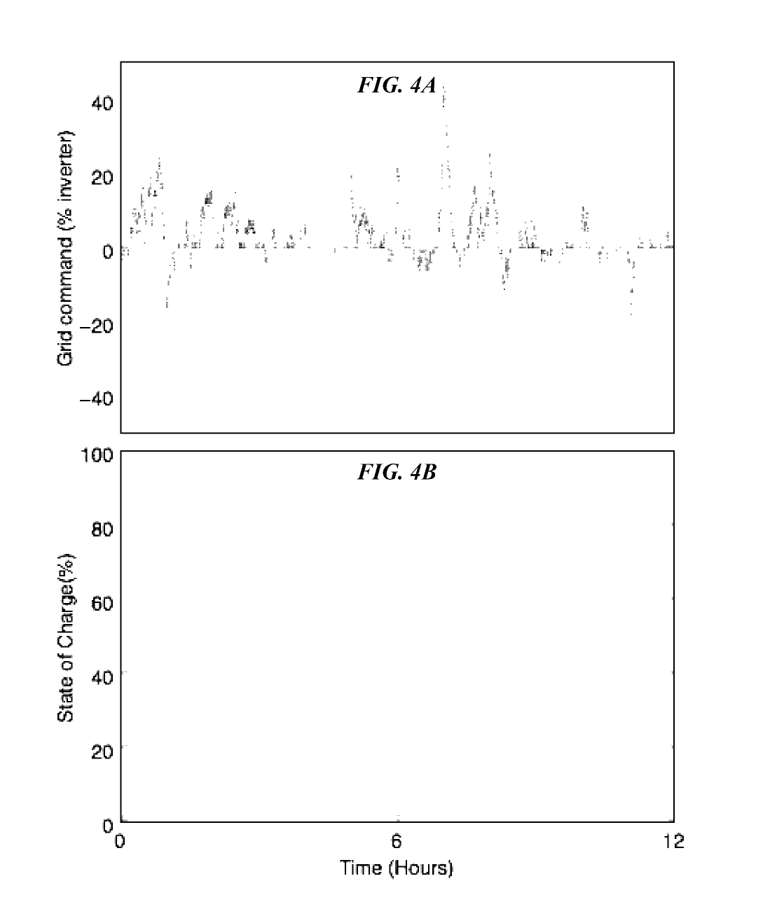

FIGS. 4A-4B illustrate the results of the operation of another embodiment of the present disclosure. FIG. 4A shows the same grid operator requests as FIG. 3A. After operating the present systems and methods, a frequency regulation system may have a state of charge (SOC) that deviates significantly from 50 percent (eventually ending above 80 percent, as shown in FIG. 4B), but still does not reach an over-charge or depleted level in the time frame shown since the reserve is used more sparingly than in the embodiment described in connection with FIGS. 3A-3B. Over a long period of time, non-performance events may occur, but they are relatively rare as compared to a program that does not use the reserve option at all.

Following the operation of the program of FIGS. 4A-4B, the payment of 3,100,000 Euros is reduced in part by energy adjustment costs of 30,000-60,000 Euros and in part by mis-performance (i.e., non-performance) penalties of 10,000-30,000 Euros. However, the remaining income is significantly higher than the case described in connection with FIGS. 3A-3B. Instead of the estimated gross income being between 1,700,000 and 2,650,000 Euros after the energy adjustment costs are deducted, the estimated gross income is between 3,000,000 and 3,050,000 Euros. Thus, substantial savings are obtained by allowing the SOC of the energy storage device to “drift” from the 50 percent level.

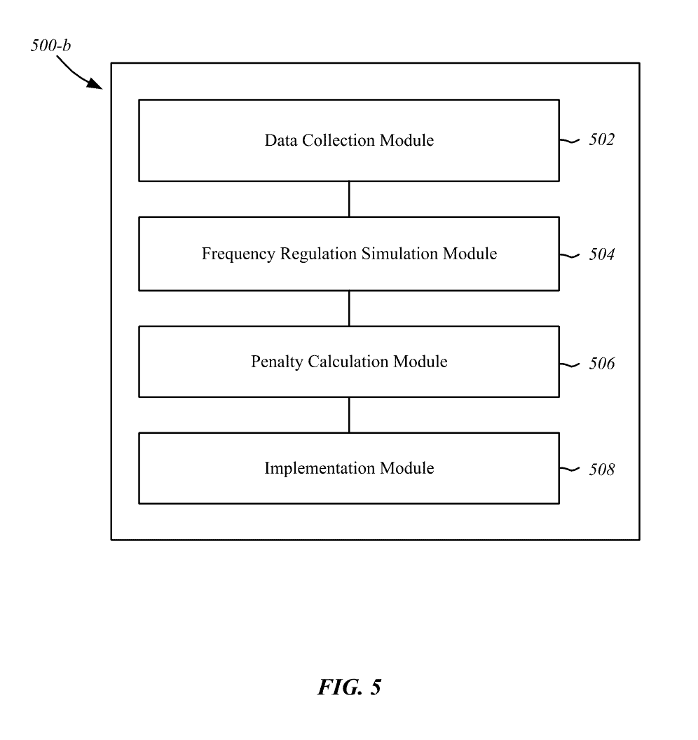

A reserve usage boundary optimization module 500-b may be used to obtain or optimize the program of FIGS. 4A-4B. An example reserve usage boundary optimization module 500-b is diagrammatically shown in FIG. 5. The reserve usage boundary optimization module 500-b may include several modules that operate as part of the overall module 500-b. This module 500-b may be implemented in the memory 215 of FIG. 2, as shown by module 500-a. The reserve usage boundary optimization module 500-b may include a data collection module 502, a frequency regulation simulation module 504, a penalty calculation module 506, and an implementation module 508.

The data collection module 502 may comprise instructions to obtain or determine historical frequency regulation data for the participant in the utility grid frequency regulation program. The historical frequency regulation data may include a plurality of historically-issued grid commands (i.e., requests) that are sent to the participant's frequency regulation system over time. Thus, the historical frequency regulation data may resemble the data shown in FIGS. 3A and 4A, wherein the grid commands include the polarity of the grid commands, the power level requested (whether in percentage of inverter capacity or in magnitude of power level required), and the times that the grid commands are issued. The historical frequency regulation data may extend over time periods such as, for example, a day, a week, a month, a year, or a longer or shorter time period.

The data collection module 502 may also comprise instructions to obtain or determine a reserve value available to the participant when participating in the utility grid frequency regulation program. The reserve value may represent the adjustment ability of the participant to change the frequency regulation requests as they are received. In one embodiment, a reserve value may be expressed as a percentage of the total capacity of the inverter or other converter used in the frequency regulation system. In another embodiment, the reserve value may be the magnitude of the capacity that the inverter's conversion power level can be changed. When the reserve value is used in executing the frequency response system, the controller may adjust the power level supplied to or drawn from the grid, but penalties may be assessed by the grid operator for doing so.

The data collection module 502 may also obtain or determine energy storage device specifications of an energy storage device used by the participant. The energy storage device may be connected to a frequency regulation controller that controls the device to charge from the grid or discharge into the grid. The specifications obtained or determined may comprise the overall energy storage capacity of the energy storage device and a state of charge of the energy storage device. The overall capacity and the state of charge may be used to determine when the energy storage device is fully charged or depleted. The state of charge obtained by the data collection module 502 may also include the starting state of charge level of the energy storage device that will be used in each iterative simulation and that will be used when an optimized control program has been developed, identified, and implemented for the frequency regulation system.

The frequency regulation simulation module 504 may receive the data collected by the data collection module 502 to simulate performance of a plurality of simulated frequency regulation operations by the energy storage device of the participant. The number of simulated frequency regulation operations may vary depending on the resources available to the user of the module 504 and the degree of precision desired in the results of the simulations. For example, in one embodiment thousands or tens of thousands of simulations may be performed in order to obtain a statistically significant number of results for the simulations to reliably estimate optimal system settings.

Each simulated frequency regulation operation may be performed to obtain cost or penalty information for a different set of simulated frequency regulation system settings. The system settings simulated in each case may comprise an upper state of charge threshold of the energy storage device and a lower state of charge threshold of the energy storage device. The upper state of charge threshold and lower state of charge threshold may each be defined as state of charge values of the energy storage device.

The frequency regulation simulation module 504 may simulate charging and discharging the energy storage device in accordance with the historical frequency regulation data (e.g., data such as that shown in FIGS. 3A and 4A) or a set of simulated frequency regulation data. When the historical grid command would require drawing power from the grid, the simulated state of charge of the energy storage device may increase at the rate required, and when the grid command would require providing power to the grid, the simulated state of charge of the energy storage device may decrease at the rate required. While the simulated state of charge of the energy storage device remains between the lower and upper state of charge thresholds, the simulated frequency regulation operations do not use the reserve power portion in order to avoid the costs and penalties that come from using the reserve. If the reserve portion is never used, the costs and penalties accrued over the course of the simulation may be zero.

In most cases, the simulated state of charge of the energy storage device will exceed the upper state of charge threshold (or may fall below the lower state of charge threshold) at least once over the course of the simulation. In response, the simulated frequency regulation operations may use the reserve portion to at least some extent. For example, if the state of charge exceeds the upper state of charge threshold and the historical frequency regulation data requires the energy storage device to continue to charge (thereby further increasing the state of charge of the device), some or all of the reserve portion may be used to reduce the rate of charging. Thus, the energy storage device will be less likely to be at full charge when another drawing command is received, and the system is less likely to be forced into non-compliance with the drawing command. If the state of charge exceeds the upper state of charge threshold and the data requires the device to discharge (thereby decreasing the state of charge), the simulation may use some or all of the reserve portion to increase the rate of discharging the simulated system, thereby making the energy storage device fall below the upper state of charge threshold more quickly than it would otherwise need to do to comply with the frequency regulation request. Comparable commands may be issued when the state of charge falls below the lower state of charge threshold in order to cause the energy storage device to discharge more slowly or to recharge more quickly than would be required, thus reducing the chance that the frequency regulation system will be unable to respond to a request due to lack of available charge in the energy storage device. A simulated frequency regulation operation may end when all of the grid commands have been simulated.

The penalty calculation module 506 may determine the total costs or penalties incurred during each simulated operation. The penalties that would occur due to non-compliance with a regulation request and the penalties due to usage of the reserve portion may be accumulated and totaled for that simulated operation of the frequency regulation system. Thus, a total cost of participating in the frequency regulation program may be determined for each simulation. Each total cost value may correlate with the upper and lower state of charge thresholds set for each simulation and/or the state of charge of the energy storage device at the start of that simulation.

The penalty calculation module 506 and/or implementation module 508 may determine which simulation or simulations have the lowest total costs and may identify the corresponding upper and lower state of charge values that produced those total costs. These upper and lower state of charge threshold values may therefore correlate with maintaining the lowest costs of participating in the frequency regulation program over the time period covered by the historical frequency regulation data. Thus, these threshold values may be likely to produce the lowest costs in an active frequency regulation system. The implementation module 508 may therefore implement the threshold values in the participant's frequency regulation system controller. In other words, the implementation module 508 may cause the frequency regulation system controller to have programming that limits usage of a reserve option to situations where the state of charge of the energy storage device of the frequency regulation system is above the upper state of charge threshold or below the lower state of charge threshold of the simulation or simulations that have the lowest total cost.

In some embodiments, the implementation module 508 may send instructions to a frequency regulation system to use the lowest-cost state of charge threshold values. For example, the implementation module 508 may be connected to a network interface (e.g., network interface 285) and send frequency regulation system controller programming and/or settings to a frequency regulation system controller that provides cost-optimized state of charge threshold values.

The energy storage device's state of health may be affected over time as it operates in the frequency regulation program. The state of health may be defined as the condition of the energy storage device (e.g., battery) compared to its ideal conditions. As a battery or other energy storage device is charged and discharged, the state of health may degrade such that the maximum capacity of the device is diminished. The number of charge cycles, self-discharge characteristics, the change in the state of charge of the device between recharges (i.e., depth of discharge or charge), and other related characteristics may affect the state of health.

In some arrangements, the reserve usage boundary optimization module 500-b may also account for costs associated with energy storage device degradation that may occur as the energy storage device is charged and discharged. Degradation of the energy storage device may be affected by the upper and lower state of charge thresholds of the active frequency regulation system. In some cases, higher upper and lower state of charge thresholds may correlate with higher rates of energy storage device health degradation. Accordingly, the reserve usage boundary optimization module 500-b may calculate the device health degradation associated with each set of upper and lower state of charge thresholds used in each simulation and include the costs of health degradation in the total cost calculation for each simulation. Costs associated with degradation of health may include energy storage device maintenance costs and/or replacement costs. Other costs caused by the health degradation may include decreased maximum storage capacity of the energy storage device over time, since the decreasing maximum capacity may make the energy storage device increasingly more prone to non-compliance events due to having too much charge.

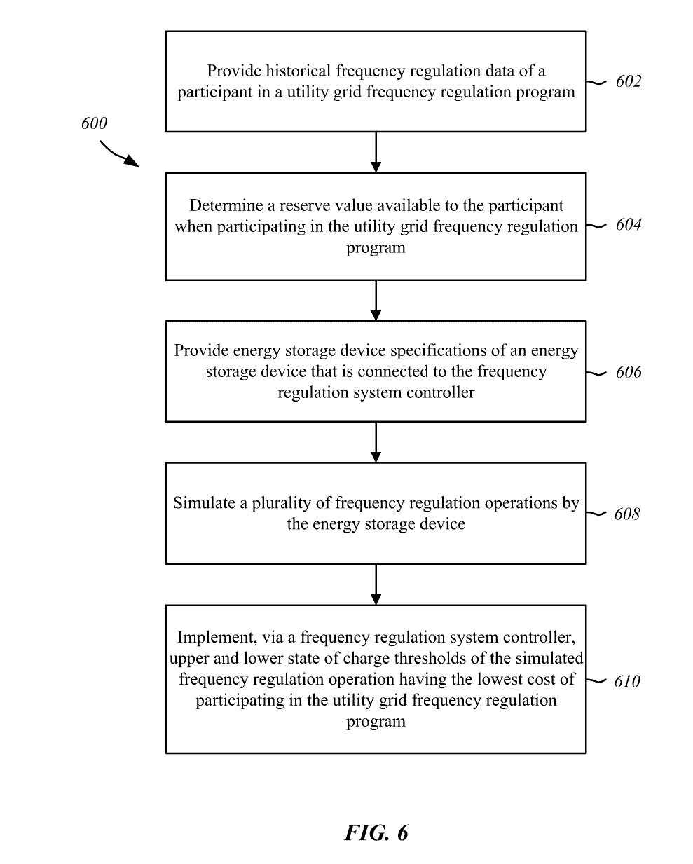

Another aspect of the present disclosure relates to a method of controlling a frequency regulation system controller of a participant in a utility grid frequency regulation program. An example method 600 is shown in a process flowchart of FIG. 6. In block 602, the method 600 includes providing historical frequency regulation data of a participant in a utility grid frequency regulation program. This may be performed by obtaining or retrieving the historical frequency regulation commands sent to the participant over a period of time. In one example, a data collection module (e.g., 502) may perform this step. In another example embodiment, a measurement system (e.g., sensors and recording equipment) may be implemented at the participant's site to monitor and record grid commands over time in order to gather the historical frequency regulation data.

In block 604, the method 600 includes determining a reserve value available to the participant when participating in the utility grid frequency regulation program. This step may be performed by obtaining or retrieving the reserve value from a database or from the participant. The reserve value may be the magnitude of power that may be used by the participant to modify grid frequency regulation commands. Alternatively, the reserve value may be expressed as a percentage of the participant's power by which the participant may modify grid commands. Using the reserve value to modify a response to a grid command may incur costs or penalties for the participant. A data collection module 502 may also perform this step. In some embodiments, this step may be omitted or performed in connection with another step.

In block 606, the method 600 includes providing energy storage device specifications of an energy storage device that is connected to the frequency regulation system controller. The data collection module 502 may also perform this step. The energy storage device in question may be the energy storage device used for frequency regulation system operations and may be charged and discharged from the utility grid when needed. The specifications provided may include the energy storage capacity and/or state of charge of the energy storage device. In some embodiments, the specifications may also comprise the state of health of the energy storage device and information about how operating in the frequency regulation program may affect the state of health of the device.

In block 608, the method 600 may include simulating a plurality of frequency regulation operations by the energy storage device. This step may be performed by a frequency regulation simulation module 504. Each simulated frequency regulation operation may include assigning an upper state of charge threshold to the energy storage device and assigning a lower state of charge threshold to the energy storage device, as described above in connection with module 504. Each of the simulated frequency regulation operations may have different upper and lower state of charge thresholds, as described in connection with module 504.

Block 608 may also include simulating charging and discharging the energy storage device in response to the historical frequency regulation data. In each simulation, the reserve value may be used only when the state of charge of the energy storage device is below the lower state of charge threshold or above the upper state of charge threshold.

Block 608 may further include calculating the cost of participating in the simulated frequency regulation operation. The cost may be dependent upon the use of the reserve value. In some embodiments, the cost may also be dependent upon occurrences of non-compliance with a grid command in the historical frequency regulation data and/or costs associated with the degradation of the state of health of the energy storage device. This block 608 may be performed by a penalty calculation module 506.

Block 610 of the method 600 may include implementing, via the frequency regulation system controller, the upper and lower state of charge thresholds of a simulated frequency regulation operation that is found to have the lowest costs/penalties for participating in the utility grid frequency regulation program. In some embodiments, this block 610 may be performed by the implementation module 508. This block 610 may also be performed by physically providing or installing (e.g., electrically or physically connecting) a frequency regulation system having a system controller with the upper and lower state of charge threshold values that correlate with minimal costs and penalties and having an energy storage device having the energy storage device specifications of block 606.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A method of controlling a frequency regulation system controller of a participant in a utility grid frequency regulation program, the method comprising:
providing historical frequency regulation data of a participant in a utility grid frequency regulation program;
providing energy storage device specifications of an energy storage device connected to a frequency regulation system, the energy storage device specifications comprising an energy storage capacity and a state of charge;
simulating a plurality of frequency regulation operations by the energy storage device, each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds;
implementing, via a frequency regulation system controller, the upper and lower state of charge thresholds of the simulated frequency regulation operation having the lowest cost of participating in the utility grid frequency regulation program.

2. The method of claim 1, further comprising determining a reserve value available to the participant when participating in the utility grid frequency regulation program.

3. The method of claim 1, wherein each simulated frequency regulation operation comprises:
assigning the upper state of charge threshold to the energy storage device and assigning the lower state of charge threshold to the energy storage device, wherein each of the simulated frequency regulation operations have different upper and lower state of charge thresholds;
simulating charging and discharging the energy storage device in response to the historical frequency regulation data, wherein a reserve value of the frequency regulation system is used only when the state of charge of the energy storage device is below the lower state of charge threshold or above the upper state of charge threshold;
calculating the cost of participating in the simulated frequency regulation operation, the cost being dependent upon the use of the reserve value.

4. The method of claim 1, wherein the cost of using the frequency regulation system of each simulated frequency regulation operation includes a cost of health degradation of the energy storage device.

5. The method of claim 1, wherein the cost of using the frequency regulation system of each simulated frequency regulation operation includes a cost of non-compliance with a frequency regulation command from a utility grid operator.

6. The method of claim 1, wherein implementing the upper and lower state of charge thresholds comprises physically providing or installing a frequency regulation system that uses upper and lower state of charge thresholds for the participant.

7. The method of claim 1, wherein the historical frequency regulation data comprises frequency regulation commands from a utility grid operator or frequency regulation program operator.

8. A computing device configured for controlling a frequency regulation system controller of a participant in a utility grid frequency regulation program, the computing device comprising:
a processor;
memory in electronic communication with the processor, wherein the memory stores computer executable instructions that, when executed by the processor, cause the processor to perform the steps of:
providing historical frequency regulation data of a participant in a utility grid frequency regulation program;
providing energy storage device specifications of an energy storage device connected to a frequency regulation system, the energy storage device specifications comprising an energy storage capacity and a state of charge;
simulating a plurality of frequency regulation operations by the energy storage device, each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds;
implementing, via a frequency regulation system controller, the upper and lower state of charge thresholds of the simulated frequency regulation operation having the lowest cost of participating in the utility grid frequency regulation program.

9. The computing device of claim 8, wherein the instructions further comprise determining a reserve value available to the participant when participating in the utility grid frequency regulation program.

10. The computing device of claim 8, wherein each simulated frequency regulation operation comprises:
assigning the upper state of charge threshold to the energy storage device and assigning the lower state of charge threshold to the energy storage device, wherein each of the simulated frequency regulation operations have different upper and lower state of charge thresholds;
simulating charging and discharging the energy storage device in response to the historical frequency regulation data, wherein a reserve value of the frequency regulation system is used only when the state of charge of the energy storage device is below the lower state of charge threshold or above the upper state of charge threshold;
calculating the cost of participating in the simulated frequency regulation operation, the cost being dependent upon the use of the reserve value.

11. The computing device of claim 8, wherein the cost of using the frequency regulation system of each simulated frequency regulation operation includes a cost of health degradation of the energy storage device.

12. The computing device of claim 8, wherein the cost of using the frequency regulation system of each simulated frequency regulation operation includes a cost of non-compliance with a frequency regulation command from a utility grid operator.

13. The computing device of claim 8, wherein the historical frequency regulation data comprises frequency regulation commands from a utility grid operator or frequency regulation program operator.

14. A non-transitory computer-readable storage medium storing computer executable instructions that, when executed by a processor, cause the processor to perform the steps of:
providing historical frequency regulation data of a participant in a utility grid frequency regulation program;
providing energy storage device specifications of an energy storage device connected to a frequency regulation system, the energy storage device specifications comprising an energy storage capacity and a state of charge;
simulating a plurality of frequency regulation operations by the energy storage device, each simulated frequency regulation operation including simulating operation of the frequency regulation system using an upper state of charge threshold for the energy storage device and a lower state of charge threshold for the energy storage device to obtain a cost of using the frequency regulation system with the upper and lower state of charge thresholds;
implementing, via a frequency regulation system controller, the upper and lower state of charge thresholds of the simulated frequency regulation operation having the lowest cost of participating in the utility grid frequency regulation program.

15. The non-transitory computer-readable storage medium of claim 14, wherein the instructions further comprise determining a reserve value available to the participant when participating in the utility grid frequency regulation program.

16. The non-transitory computer-readable storage medium of claim 14, wherein each simulated frequency regulation operation comprises:
assigning the upper state of charge threshold to the energy storage device and assigning the lower state of charge threshold to the energy storage device, wherein each of the simulated frequency regulation operations have different upper and lower state of charge thresholds;
simulating charging and discharging the energy storage device in response to the historical frequency regulation data, wherein a reserve value of the frequency regulation system is used only when the state of charge of the energy storage device is below the lower state of charge threshold or above the upper state of charge threshold;
calculating the cost of participating in the simulated frequency regulation operation, the cost being dependent upon the use of the reserve value.

17. The non-transitory computer-readable storage medium of claim 14, wherein the cost of using the frequency regulation system of each simulated frequency regulation operation includes a cost of health degradation of the energy storage device.

18. The non-transitory computer-readable storage medium of claim 14, wherein the cost of using the frequency regulation system of each simulated frequency regulation operation includes a cost of non-compliance with a frequency regulation command from a utility grid operator.

19. The non-transitory computer-readable storage medium of claim 14, wherein the historical frequency regulation data comprises frequency regulation commands from a utility grid operator or frequency regulation program operator.
